(19) United States
(12) Patent Application Publication
(10) Pub. No.: US 2005/0067889 A1
(43) Pub. Date: Mar. 31, 2005

(54) Brake-by-wire input device arrangment

(76) Inventors: Adrian B. Chernoff, Royal Oak, MI (US); Joseph F. Szczerba, Grand Blanc, MI (US)

Correspondence Address: KATHRYN A MARRA;General Motors Corporation, Mail Code 482-C23-B21, P.O. Box 300, Detroit, MI, 48265-3000, US

(21) Appl. No.: 10/675,835

(22) Filed: Sep. 30, 2003

(51) Int. Cl. B60T 8/36

(52) U.S. Cl. 303/20; 303/119.2

(57) ABSTRACT

A vehicle includes a steering column supporting a brake-by-wire input device. The input device includes a member manipulable by a driver to indicate driver intent to apply brakes. A transducer converts driver manipulation of the member to electronic control signals and transmits the electronic control signals to the brake-by-wire system. The member is adjacent to a driver's hands on a steering wheel, enabling a driver to apply the brakes with minimal movement of the driver's hands.

### TECHNICAL FIELD

This invention relates to vehicles having a steering column including a steering shaft and a brake-by-wire input device supported by the steering column.

### BACKGROUND OF THE INVENTION

Prior art vehicles typically include a brake pedal adjacent to the vehicle floor and adapted for operation by a driver's foot. Prior art vehicles also typically include a steering wheel situated and configured for operation by a driver's hands.

### SUMMARY OF THE INVENTION

A vehicle is provided that includes a steering column having a rotatable steering shaft. A steering hand wheel is operatively connected to the steering shaft. The vehicle also includes a braking system responsive to electronic control signals. A driver-operable control input device is supported by the steering column and includes a member manipulable by a driver of the vehicle. The member is operatively connected to a transducer that converts driver manipulation of the member into electronic control signals. The transducer transmits the electronic control signals to the braking system.

The driver-operable control input device is configured for operation by either or both of a driver's hands and, being supported by the steering column, is adjacent to the driver's hands on the steering wheel. Thus, the driver may activate the braking system without moving her hands far from the steering wheel and without having to employ a foot pedal.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a driver-operable braking system input device supported by a steering column and operatively connected to a brake-by-wire system;

FIG. 2 is a schematic perspective view of two alternative driver-operable braking system input devices supported by a steering column; and

FIG. 3 is a schematic side view of yet another alternative driver-operable braking system input device supported by a steering column.

### DESCRIPTION OF THE PREFERRED EMBODIMENTS

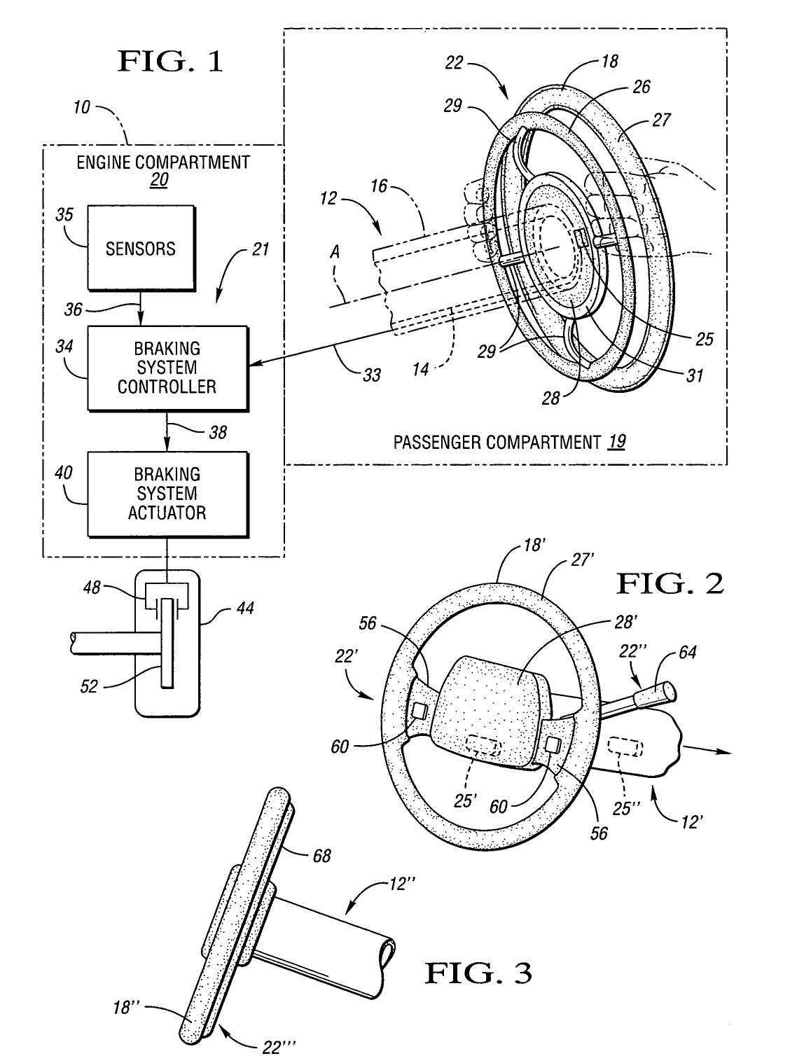

Referring to FIG. 1, a vehicle 10 includes a steering column 12. The steering column 12 includes a steering shaft 14 rotatably supported on a stationary structural housing 16. The vehicle 10 also includes a steering hand wheel 18 connected to the steering shaft 14 for unitary rotation therewith about axis of rotation A. The steering shaft extends between a passenger compartment 19 and an engine compartment 20 for transmitting mechanical steering control signals from a driver to a mechanical or hydraulic steering system. Within the scope of the claimed invention, “steering shaft” may or may not refer to two or more shafts connected by joints. For example, a steering shaft may be jointed to enable a tilt-adjustable steering wheel.

The vehicle 10 also includes a by-wire braking system 21, i.e., a braking system responsive to electronic control signals. A driver-operable input device 22 is attached to the steering wheel and therefore is supported by the steering column 12. The input device 22 includes a braking ring 26 adjacent the backside of the rim 27 of the steering wheel 18 such that the braking ring and the steering wheel have a common axis of rotation A. The braking ring 26 is connected to the hub 28 of the steering wheel 18 by spokes 29 and an annular support portion 31. The braking ring 26 is movable between a fore position and an aft position with respect to the vehicle 10, and is preferably spring biased in the fore position.

The braking ring is a member that is manipulable by a driver of the vehicle 10. That is, the driver exerts force on the braking ring 26 to move the ring 26 aft, i.e., rearward toward the driver, to indicate driver intent to apply brakes. The braking ring 26 is operatively connected to a transducer 25 that converts the effects of driver manipulation of braking ring 26 to electronic braking control signals 33. More specifically, the transducer 25 employs various sensors to measure, and generate signals 33 indicative of, the relative position of the braking ring 26 with respect to the steering wheel 18, the force exerted on the braking ring 26, and the velocity of the braking ring 26 with respect to the steering wheel 18.

Input device 22 is hand-operated, that is, it is configured and positioned such that a vehicle driver in a driving position can access and operate the input device 22 with a hand, rather than with a foot. The transducer 25 transmits the electronic control signals 33 to a braking system controller 34. A controller typically includes a microprocessor, ROM and RAM and appropriate input and output circuits of a known type for receiving various input signals and for outputting various signals.

Sensors 35 within the vehicle 10 monitor the vehicle and various vehicle components. The sensors 35 may include position sensors, velocity sensors, acceleration sensors, pressure sensors, force and torque sensors, etc. The sensors 35 transmit sensor signals 36 to the controller 34. The sensor signals 36 are indicative of various states or conditions of the vehicle 10 and its components, such as vehicle speed, steering angle, angular wheel velocity, applied brake caliper force, etc.

The controller 34 is configured to process the electronic control signals 33 and the sensor signals 36 according to a predetermined algorithm to generate actuator control signals 38. For example, the controller may process both the position and velocity of the braking ring to provide both normal and panic stopping, and take into account vehicle speed, etc., in generating actuator control signals 38.

Actuator control signals 38 are transmitted to a braking system actuator 40 that is configured to generate predetermined mechanical responses to the actuator control signals 38. Those skilled in the art will recognize a variety of braking system actuators that may be employed within the scope of the claimed invention. For example, the braking system actuator 40 may be an eletro-hydraulic actuator, a servo-motor, a solenoid, etc. The braking system actuator 40 is operatively connected to a wheel 44 and selectively causes resistance to the rotation of the wheel 44 in response to actuator control signals 38 from the braking system controller 34. In the embodiment depicted, the braking system actuator is operatively connected to brake calipers 48 and selectively causes the calipers 48 to engage a brake rotor 52. Within the scope of the claimed invention, other brake configurations may be employed, such as the use of electric motors for regenerative braking.

Active force feedback is preferably employed to simulate vehicle dynamic conditions and enhance driving performance. With active force feedback, an actuator (not shown) is operatively connected to the braking ring 26 to vary the resistance of the braking ring 26 to movement by the driver in response to vehicle conditions measured by sensors 35.

Exemplary brake-by-wire systems are described in U.S. Pat. Nos. 5,366,281, issued Nov. 22, 1994 to Littlejohn; and 6,390,565, issued May 21, 2002 to Riddiford, et al., which are hereby incorporated by reference in their entireties. U.S. Pat. No. 6,390,565 describes a brake-by-wire system that provides the capability of both travel and force sensors in a braking transducer connected to a brake apply input member such as a brake pedal and also provides redundancy in sensors by providing the signal from a sensor responsive to travel or position of the brake apply input member to a first controller and the signal from a sensor responsive to force applied to a brake apply input member to a second controller. The first and second controllers are connected by a bi-directional communication link whereby each controller may communicate its received one of the sensor signals to the other controller. In at least one of the controllers, linearized versions of the signals are combined for the generation of first and second brake apply command signals for communication to braking actuators. If either controller does not receive one of the sensor signals from the other, it nevertheless generates its braking actuator control signal on the basis of the sensor signal provided directly to it. In a preferred embodiment of the system, a controller combines the linearized signals by choosing the largest in magnitude.

FIG. 2, wherein like reference numbers refer to like components from FIG. 1, schematically depicts alternative embodiments of the brake input device 22′, 22″, which may or may not be employed together on a common vehicle. A steering wheel 18′ is characterized by two spokes 56 connecting the hub 28′ and the rim 27′. Input device 22′ includes a push button 60 on each spoke 56. The push buttons 60 are members on which a driver exerts a force to cause the buttons 60 to move relative to the steering wheel 18′. Transducer 25′ generates electronic braking control signals in response to driver manipulation of the buttons 60.

Input device 22″ includes a stalk 64 protruding from steering column 12′. A transducer 25″ is operatively connected to the stalk such the transducer 25″ generates electronic braking control signals in response to a driver pushing or pulling on the stalk 64.

Referring to FIG. 3, wherein like reference numbers refer to like components from FIGS. 1 and 2, another alternative brake input device 22′″ is schematically depicted. Input device 22′″ includes a pressure-sensitive pad 68 on the back of the rim of steering wheel 18″. Electronic braking control signals are generated by a driver exerting a force with her fingers on the pad 68.

While the best modes for carrying out the invention have been described in detail, those familiar with the art to which this invention relates will recognize various alternative designs and embodiments for practicing the invention within the scope of the appended claims.

1. A vehicle comprising:
a steering column including a steering shaft; a steering hand wheel operatively connected to the steering shaft; a by-wire braking system responsive to electronic control signals; a driver-operable control input device supported by the steering column and including a member manipulable by a driver; and a transducer operatively connected to the member to convert the effects of driver manipulation of the member to electronic control signals and transmit the electronic control signals to the by-wire braking system.

2. The vehicle of claim 1, wherein the member is a braking ring adjacent to the steering hand wheel.

3. The vehicle of claim 2, wherein the steering hand wheel and the braking ring are characterized by a common axis of rotation.

4. The vehicle of claim 1, wherein the member is a button on the steering hand wheel.

5. The vehicle of claim 1, wherein the member is a pressure-sensitive pad on the steering wheel.

6. The vehicle of claim 5, wherein the steering hand wheel is characterized by a rim, and wherein the pressure-sensitive pad is on the rim.

7. The vehicle of claim 1, wherein the member is a stalk mounted on the steering column.

8. A vehicle having a passenger compartment and an engine compartment, the vehicle comprising:
a steering column including a rotatable steering shaft extending from the passenger compartment to the engine compartment;
a steering hand wheel operatively connected to the steering shaft for unitary rotation therewith;
a by-wire braking system responsive to electronic control signals;
a driver-operable control input device supported by the steering column and including a braking ring manipulable by a driver and connected to the steering wheel for unitary rotation therewith; and
a transducer operatively connected to the braking ring to convert the effects of driver manipulation of the braking ring to electronic control signals and transmit the electronic control signals to the by-wire braking system.

9. A brake-by-wire input arrangement comprising:
a steering column including a steering shaft; a steering hand wheel operatively connected to the steering shaft; a brake-by-wire input device including a member on the steering column or the steering hand wheel and manipulable by a driver; and a transducer operatively connected to the member to convert driver manipulation of the member to electronic braking control signals.

10. The brake-by-wire input arrangement of claim 9, wherein the member is a braking ring adjacent to the steering hand wheel.

11. The brake-by-wire input arrangement of claim 10, wherein the steering hand wheel and the braking ring are characterized by a common axis of rotation.

12. The brake-by-wire input arrangement of claim 9, wherein the member is a button on the steering hand wheel.

13. The brake-by-wire input arrangement of claim 9, wherein the member is a pressure-sensitive pad on the steering wheel.

14. The brake-by-wire input arrangement of claim 13, wherein the steering hand wheel is characterized by a rim, and wherein the pressure-sensitive pad is on the rim.

15. The brake-by-wire input arrangement of claim 9, wherein the member is a stalk mounted on the steering column.
